(19) United States
(12) Patent Application Publication
(10) Pub. No.: US 2011/0237728 A1
(43) Pub. Date: Sep. 29, 2011

(54) CROSSLINKABLE POLYMER BINDER

(75) Inventors: Dirk Emiel Paula MESTACH, NIJLEN (BE); Anneke VAN DER ZANDE, BERGEN OP ZOOM (NL)

(73) Assignee: NUPLEX RESINS B.V., BERGEN OP ZOOM (NL)

(21) Appl. No.: 13/157,330

(22) Filed: Jun. 10, 2011

Related U.S. Application Data
(63) Continuation of application No. PCT/EP2009/067001, filed on Dec. 11, 2009.

(30) Foreign Application Priority Data
Dec. 12, 2008 (GB) 0822674.8

(51) Int. Cl. C08K 5/05; C08F 8/30; C08L 75/14; C09D 175/04

(52) U.S. Cl. 524/379; 528/85; 524/555

(57) ABSTRACT

The invention relates to a crosslinkable polymer binder comprising a polyurethane macromer and grafted thereon a vinyl polymer, to an aqueous dispersion comprising said crosslinkable polymer binder and to a process for the manufacture of said crosslinkable polymer binder and said aqueous dispersion thereof. The crosslinkable polymer binder can be used in coating compositions or adhesives.

### CROSS-REFERENCE TO RELATED APPLICATIONS

This application is a continuation of PCT application number PCT/EP2009/067001, which was filed on 11 Dec. 2009, and which claims priority from United Kingdom application number UK 0822674.8 filed on 12 Dec. 2008. Both applications are hereby incorporated by reference in their entireties.

### BACKGROUND OF THE INVENTION

1. Field of the Invention

The invention relates to a crosslinkable polymer binder comprising a polyurethane macromer and grafted thereon a vinyl polymer, to an aqueous dispersion comprising said crosslinkable polymer binder and to a process for the manufacture of said crosslinkable polymer binder and said aqueous dispersion thereof. The crosslinkable polymer binder can be used in coating compositions or adhesives.

2. Description of Related Art

Recent changes in the legislation concerning the emission of organic solvents have led to a growing interest in water borne coating systems for industrial applications. Water borne coating systems have already been in use for a long time in applications where the decorative aspects of the coating were more important than the protective properties. The aqueous polymer dispersions being used as binders are quite often acrylic polymers, prepared by means of an emulsion polymerization process. A general description of the emulsion polymerization process is given in E. W. Duck, Encyclopedia of Polymer Science and Technology (John Wiley & Sons, Inc.: 1966), Vol. 5, pp. 801-859, which is hereby incorporated by reference in its entirety. A serious drawback to the conventional emulsion polymerization process is that in this process substantial amounts of surfactants must be used. Surfactants perform many functions in emulsion polymerization, including solubilizing hydrophobic monomers, determining the number and size of the dispersion particles formed, providing dispersion stability as particles grow, and providing dispersion stability during post-polymerization processing. Typical examples of surfactants used in emulsion polymerization are anionic surfactants like fatty acid soaps, alkyl carboxylates, alkyl sulphates, and alkyl sulfonates; nonionic surfactants like ethoxylated alkylphenol or fatty acids used to improve freeze-thaw and shear stability; and cationic surfactants like amines, nitriles, and other nitrogen bases, rarely used because of incompatibility problems. Often a combination of anionic surfactants or anionic and nonionic surfactants is used to provide improved stability.

The use of surfactants in emulsion polymerization leads to a number of problems when the resulting polymeric dispersions are being used in film-forming compositions such as coatings, printing inks, adhesives, and the like. Since conventional surfactants or emulsifiers are highly water-sensitive they impart poor water resistance to the films formed from the polymer dispersion. Furthermore, conventional surfactants or emulsifiers often act as plasticizer for the polymers, resulting in reduced hardness of the polymeric film. Another potential problem is the tendency of surfactant molecules to migrate to the polymer/air or polymer/substrate interface, often resulting in deleterious effects such as deteriorated esthetical properties like loss of gloss, cloudiness at the surface, loss of adhesion.

Surfactant free emulsion polymerization in the presence of a stabilizing polymer is known in the art. U.S. Pat. No. 4,151,143 discloses a surfactant-free polymer emulsion polymerization wherein a conventional carboxyl group containing polymer is neutralised en emulsified in water. A second stage polymer is than prepared in the presence of the emulsified first polymer. Also the use of other stabilizing polymers such as water-reducible polyurethanes has been described for example in U.S. Pat. No. 4,820,762.

One of the drawbacks of the methods mentioned above is that phase-separation occurs between the stabilizing polymer and the main polymer detracting from the properties in the final application. A known way to overcome this problem is to use a stabilizing polymer that contains groups that can participate in a free radical polymerization process such as ethylenically unsaturated groups or thiol groups. Various ways to covalently link the stabilizing polymer to the acrylic polymer have been proposed.

EP 0 167 188 describes the synthesis of oligo-urethanes having unsaturated terminal groups. These oligo-urethanes are emulsified in water and a free radical initiator is added to polymerize the terminal double bonds.

EP 0 522 419 describes polyurethane-acrylic hybrid dispersions. The oligo urethanes possess multiple lateral and optionally terminal ethylenically unsaturated groups. EP 0 522 420 describes of process to produce crosslinkable polyurethane-acrylic hybrids where a carbonyl-functional monomer is incorporated in the acrylic part of the polymer. A polyhydrazide is added to the polymer to affect crosslinking. In both publications problems in film formation occur resulting in inadequate mechanical strength and barrier properties for a film made from the binder.

Recently H. J. Adler et al. (Progress in Organic Coatings 43 (2001) 251-257) described a novel class of polyurethane stabilizers where about 50% of the polymer contains one methacryloyl and one dodecane end-group and carboxylic acid groups. Because of the amphiphilic nature of these polymers they can form micelles in aqueous medium and hence are suitable to act as stabilizers in an emulsion polymerization process.

### BRIEF SUMMARY OF THE INVENTION

The inventors have now found that these stabilizers are suitable in the emulsion polymerization of ethylenically unsaturated monomers comprising carbonyl functional monomers. These binders can be cross-linked at ambient temperatures with compounds that are co-reactive towards the carbonyl functional groups to yield films that are well coalesced and display the properties required for the use in coating and printing ink applications.

U.S. Pat. No. 5,623,016 describes an aqueous crosslinkable binder comprising a polyurethane macromer and grafted thereon a vinyl polymer, wherein the macromer is prepared by reacting polyhydroxy compounds, polyisocyanates, vinyl monomers and hydrophilic monomers containing hydrophilic groups to form a vinyl containing urethane macromer having terminal vinyl groups for grafting with the vinyl polymer. The vinyl polymer comprises vinyl monomers having one or more carbonyl groups for cross linking with polyhydrazides. The disadvantage of this process is that the resulting product has relatively poor film forming properties, as exemplified in relatively low hardness and poor chemical resistance properties.

Hirose, in “Organic coatings 41 (1979) 157-169”, describes a crosslinkable binder comprising a polyurethane macromer and grafted thereon a vinyl polymer, wherein the vinyl polymer comprises monomers having carbonyl groups for later crosslinking with poly-hydrazides. In Hirose, the macromer is prepared by reacting a poly-caprolactone polyol, a polyester polyol, di-methylol propionic acid in the presence N-methylpyrrolidone and ethyl acetate as solvents for the monomers. After addition of isophorone diisocyanate the polyurethane macromer is formed after which a low amount of hydroxyethyl methacrylate is added to provide vinyl groups for later grafting with the vinyl polymer. Subsequently, further ethyl acetate solvent and vinyl monomers are added to the thus formed solution and reacted to form the binder material. The organic solvents, in particular the ethyl acetate are removed under vacuum by distillation. The resulting binder is added to water for making an aqueous dispersion.

The disadvantage of the process described by Hirose and the resulting product is that the solvents must be removed but cannot be removed completely and will hence affect the properties of the resulting binder. In particular the N-methylpyrrolidon used to dissolve the dimethylol propionic acid cannot be removed from the binder. A further disadvantage of the binder described by Hirose is that the binder has relatively poor properties as a coating material. The resistant to chemicals and the mechanical properties of the coatings comprising the binder of Hirose are inadequate. It is believed that this is due to a relatively poor grafting of the vinyl polymer on the polyurethane macromer resulting from the relatively low amount of vinyl functional graft monomer. A low amount of graft monomer is necessary of the process of Hirose to prevent cross linking during the preparation of the binder.

There hence exists a desire to provide an aqueous crosslinkable polymer binder wherein at least one of the above mentioned disadvantages has been overcome, in particular having improved film forming properties and/or good chemical resistance and/or good mechanical properties in application as a coating.

This object has according to the invention been achieved by a crosslinkable polymer binder comprising a polyurethane macromer and grafted thereon a vinyl polymer, the macromer being prepared by reacting:
I a monomer (I) comprising 2 or more hydroxy functional groups,
II a monomer (II), comprising 2 or more isocyanate functional groups,
III a stabilizing monomer (III) comprising ionically and/or non-ionically stabilising groups,
IV a graft monomer (IV) having only one group reactive with monomer I or II and one vinyl group,
V a chain stopper monomer (V) having only one group reactive with monomer I or II,
   wherein at least 30 mole %, of the macromers have only one graft monomer IV and less than 50 mole % of the macromers have two or more graft monomers IV, wherein the vinyl polymer is linked to the vinyl group of graft monomer IV and wherein the vinyl polymer and/or the macromer comprise crosslinkable groups.

The inventors found that the crosslinkable polymer binder provides several advantages, in particular having improved film forming properties, good chemical resistance and/or good mechanical properties in application as a coating as will be illustrated by the examples.

### DESCRIPTION OF ILLUSTRATIVE EMBODIMENTS

The following is a description of certain embodiments of the invention, given by way of example only. The polyurethane macromer in the binder polymer preferably is linear and monomer (I) comprises 2 hydroxy functional groups and monomer (II) comprise 2 isocyanate functional groups. The advantage of a linear macromer is that better film forming properties are obtained. The polyurethane macromer not only acts as stabiliser in the addition polymerisation of the vinyl polymer part, but is also an essential component of the binder composition. The amount of polyurethane macromer in the binder can range between 5 and 95 wt %, more preferably between 20 and 70 wt %, even more preferably between 30 and 60 wt % (relative to the total weight of polyurethane and vinyl polymer). The molecular weight of the macromer can in principle also vary between wide ranges, but the molecular weight should not be too high to get acceptable viscosity for handling, and acceptable flow properties in a coating. On the other hand, the molecular weight should not be too low to get acceptable coating properties like mechanical and chemical resistance. Therefore, preferably the weight average molecular weight is at least 3,000 and at most 50,000 gr/mol. In view of stabilising ability in emulsion polymerisation, the macromer preferably has a molecular weight of at least 3,000, more preferably at least 3500 and even more preferably at least 4000 gr/mol and preferably at most 50,000, more preferably at most 40,000, even more preferably at most 35,000 and most preferably at most 30,000 gr/mol (weight average molecular weight as determined by GPC).

In the polymer binder, monomer II is preferably present in such amount to provide a molar excess of isocyanate groups relative to isocyanate reactive groups in monomers I and III, preferably in an amount sufficient to form isocyanate terminated macromers and wherein monomer IV and V comprise only one isocyanate-reactive group. Preferred isocyanate-reactive groups are hydroxy groups and amine groups. Preferably, the molar amount of isocyanate reactive groups in monomer IV and V is equal or more than the amount of isocyanate groups. A possible but less preferred alternative is that monomer I is present in such amount to provide a molar excess of hydroxy functional groups relative to isocyanate reactive groups in monomers I and III, preferably in an amount sufficient to form hydroxy terminated macromers and wherein monomer IV and V comprise only one hydroxy reactive groups, preferably an isocyanate.

The invention also relates to a process for the manufacturer of the binder according to the invention, comprising the steps of,

1) forming a macromer by reacting;
I a monomer (I) comprising 2 or more hydroxy functional groups,
II a monomer (II), comprising 2 or more isocyanate functional groups,
III a stabilizing monomer (III) comprising ionically and/or non-ionically stabilising groups,
IV a graft monomer (IV) having only one group reactive with monomer I or II and one vinyl group,
V a chain stopper monomer (V) having only one group reactive with monomer I or II,
   wherein the amount of mono-alcohol chain stopper monomer V relative to the amount of graft component IV is chosen such that at least 30 mole % of the macromers have only one graft monomer IV and less than 50 mole % of the macromers have two or more graft monomers IV;

2) adding vinyl monomer and preferably an inhibitor before, during or after step 1;

3) optionally neutralizing the obtained reaction product,

4) emulsifying the obtained reaction product in water;

5) after emulsifying adding a radical starter to react the vinyl monomers,

wherein the vinyl polymer and/or the macromer comprise crosslinkable groups.

In the production process of the macromer, macromers having zero, one and two or more graft monomers IV are all present. The relative amounts of these macromers depend on a statistical process and hence are present in a statistical distribution depending in particular on the molar ratio of monomers IV and V. In order to get the advantageous properties of the binder; in particular a low percentage of macromers having zero graftable vinyl groups, a low percentage having two or more graftable vinyl groups and a high percentage having only one graftable vinyl group, the ratio of molar amount of monomer IV to V is most preferably chosen close to 1, so preferably is 0.5:1 to 2:1, more preferably 0.75:1 to 1.25:1, even more preferably 0.9:1 to 1.1:1. As a result, the number of macromers having 2 or more graft monomers is at most 35 mole %, preferably at most 30 mole %, the number of macromers having no graft monomers is at most 35 mole %, preferably at most 30 mole % and the number of macromers having only 1 graft monomers is between 20 and 80 mole %, preferably between 40 and 60 mole %, preferably more than 50 mole %.

In the process the vinyl monomers of step 2 can be added in one step or can be added in at least 2 portions having a different composition of vinyl monomers. Reaction step 1 is preferably performed using vinyl monomers of step 2 and/or mono-alcohol monomer V as reaction solvent, preferably without using additional solvents. In this case no solvent removal step is required. In this case vinyl monomer can be added before as well as after forming the macromer in step 1.

The monomer (I) comprising 2 or more hydroxy-functional groups is generally selected, for example, from polyetherpolyols, polyester polyols, hydroxypolyesteramidepolyols, polycarbonatepolyols and polyolefinepolyols. Besides polymeric polyols, also low molecular weight glycols, for example, glycol itself, di- or triethylene glycol, 1,2-propanediol or 1,3-propanediol, 1,4-butanediol, neopentylglycol, hexane-1,6-diol, cyclohexanedimethanol, 2,2-bis(4′-hydroxycyclohexyl)propane can be used. Mixtures of different polyol monomers can be used. The preferred diol monomer (I) is a polyester diol or a polycaprolactone polyol. These polyols can have number averaged molecular weights of 500 to 6000, preferably 600 to 4000.

Examples of polyetherpolyols that can be are polyethylene glycols, polypropylene glycols, copolymers thereof, and polytetramethylene glycols. Polytetramethylene glycols having a number average molecular weight of from 400 to 5000 are preferred.

The polyesterpolyols are generally prepared by esterification of polycarboxylic acids or their anhydrides with organic polyhydroxy compounds. The polycarboxylic acids and the polyhydroxy compounds may be aliphatic, aromatic or mixed aliphatic/aromatic. Suitable polyhydroxy compounds are alkylene glycols such as glycol, 1,2-propanediol and 1,3-propanediol, 1,4-butanediol, neopentyl glycol, hexane-1,6-diol, cyclohexanedimethanol, 2,2-bis(4′-hydroxycyclohexyl)propane, and polyhydric alcohols such as trishydroxyalkylalkanes (e.g., trimethylolpropane) or tetrakishydroxyalkylalkanes (e.g., pentaerythritol). Other polyhydroxy compounds suitable for esterification may also be used.

Polycarboxylic acids that can be used in the synthesis of polyesterpolyols are, for example, phthalic acid, isophthalic acid, terephthalic acid, tetrahydrophthalic acid, hexahydrophthalic acid, succinic acid, adipic acid, azelaic acid, sebacic acid, maleic acid, glutaric acid, hexachloroheptanedicarboxylic acid, tetrachlorophthalic acid, trimellitic acid and pyromellitic acid. Instead of these acids it is also possible to use their anhydrides where these exist. Dimeric and trimeric fatty acids can also be employed as polycarboxylic acids. Other polycarboxylic acids suitable for esterification may also be used.

Other suitable hydroxypolyesterpolyols are derived from polylactones which are obtainable by, for example, reacting epsilon, caprolactone with glycols. Examples of glycols which are suitable for reaction with the lactone are ethylene glycol, 1,3-propanediol, 1,4-butanediol, 1,6-hexanediol and dimethylolcyclohexane. As glycol also the condensation product of dimethylol propionic acid and epsilon-caprolactone may also be used.

Polyester amidepolyols are derived, for example, from polycarboxylic acids and amino alcohols as a mixture with polyhydroxy compounds. Suitable polycarboxylic acids and polyhydroxy compounds are described under (A2), while examples of suitable amino alcohols are ethanolamine and monoisopropanolamine. Other suitable amino alcohols can also be used.

The polycarbonatepolyols can be prepared by reaction of polyols, such as 1,3-propanediol, 1,4-butanediol, 1,6-hexanediol, diethylene glycol, triethylene glycol, 1,4-bishydroxymethylcyclohexane, 2,2-bis(4′-hydroxycyclohexyl)propane and neopentyl glycol with dicarbonates such as dimethyl, diethyl or diphenyl carbonate, or with phosgene. Mixtures of such polyols can also be employed.

The polyolefinpolyols are generally derived, for example, from oligomeric and polymeric olefins preferably having at least two terminal hydroxyl groups, with alpha, omega-dihydroxypolybutadiene being preferred.

Further dihydroxy compounds, which are likewise suitable, are, inter alia, polyacetals, polysiloxanes and alkyd resins.

Monomer (II) comprising 2 or more isocyanate functional groups can be any conventionally used polyisocyanate in polyurethane chemistry. Examples of suitable polyisocyanates include trimethylene diisocyanate, tetramethylene diisocyanate, pentamethylene diisocyanate, hexamethylene diisocyanate, 1,5-diisocyanato-2-methylpentane, 1,12-diisocyanatododecane, propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-tolylene diisocyanate, 2,6-tolylene diisocyanate, 4,4′-biphenylene diisocyanate, 1,5-naphthylene diisocyanate, 1,4-naphthylene diisocyanate, 1-isocyanatomethyl-5-isocyanato-1,3,3-trimethylcyclohexane, bis(4-isocyanatocyclohexyl)methane, 2,2-bis(4′-isocyanatocyclohexyl)propane, 4,4′-diisocyanatodiphenyl ether, 2,3-bis(8-isocyanatooctyl)-4-octyl-5-hexylcyclohexene and tetramethylxylylene diisocyanate. Mixtures of such diisocyanates can also be employed.

Monomers I and II can comprise crosslink functionality, preferably a carbonyl group for imparting crosslinkability on drying of the binder composition. Suitable monomers are known in the art.

In view of obtaining a good colloidal stability of the final dispersion, the polyurethane macromer preferably comprises a hydrophilic moiety formed by a stabilizing monomer III and optionally a hydrophilic moiety formed by monomer I and/or chain stopper monomer V. Possible ionically and/or non-ionically stabilising monomers III are monomers having a hydrophilic moiety, like a carboxylic group, a tertiary amine group or a polyoxyethylene group and at least one, preferably two groups that can react with monomers I or II. Preferably, the ionically and/or non-ionically stabilizing monomer (III) contains at least one functional group that is reactive towards isocyanate such as a hydroxyl, an amine or a mercapto group. Preferably, monomer III comprising 2 isocyanate reactive groups, such that the monomer can be build into the polyurethane chain, preferably a diol containing an ionic group and/or a non-ionically stabilizing group.

Suitable ionic stabilising groups are carboxyl, phosphono or sulfo groups. Examples of this group of monomers are dihydroxypropionic acid, dimethylol butyric acid, dimethylol propionic acid, dihydroxyethylpropionic acid, dimethylolbutyric acid, 2,2-dihydroxysuccinic acid, tartaric acid, dihydroxy tartaric acid, dihydroxymaleic acid, dihydroxybenzoic acid, 3-hydroxy-2-hydroxymethylpropanesulfonic acid and 1,4-dihydroxybutanesulfonic acid. These monomers can be neutralised before the reaction, using a tertiary amine such as, for example, trimethylamine, triethylamine, dimethylaniline, diethylaniline or triphenylamine, in order to avoid the acid group reacting with the isocyanate. Optionally, it is possible not to neutralize the acid groups until after their incorporation into the polyurethane macromonomer. It is also possible that the stabilizing group is a cationic or cationogenic group, for example, a (substituted) ammonium or amino group.

Suitable non-ionically stabilizing groups are a polyalkylene oxide group such as polyethyleneglycol or polypropyleneglycol, or mixed polyethyleneoxypropyleneoxy groups or a polyoxazoline group, or alkoxylated trimethylolpropanes, like the product Y-mer N120 from Perstorp, ethoxylated ethanolamines. Further examples of suitable monomers are reaction products of diisocyanates containing groups of different reactivity with a polyalkylene glycol, exhibiting an isocyanate function, followed by reaction of this isocyanate with a dialkanolamine such as diethanolamine.

The graft monomer (IV) has only one group reactive with monomer I or II and one vinyl group. The graft monomer IV acts as a chain stopper in the formation of the polyurethane resulting in a macromer having terminal graft functionality for grafting with the vinyl polymer. The vinyl group can be substituted or unsubstituted with further (ar)alkyl or aryl groups optionally with heteroatoms like oxygen or nitrogen.

Examples of monomer IV are monovinyl monohydroxy compounds such as hydroxy functional esters or acrylic or methacrylic acid hydroxyethyl methacrylate, hydroxyethyl acrylate, hydroxypropyl acrylate, hydroxypropyl methacrylate, hydroxybutyl acrylate, and the like. Also adducts of hydroxy-functional monomers with ethylene or propylene oxide can be used. Furthermore, also monomers having latent hydroxy groups, such as glycidyl (meth)acrylate can be used.

Other suitable monovinyl monohydroxy compounds may also be used. Other examples are amino-containing (meth)acrylates, reaction products of monoepoxides and α-β unsaturated carboxylic acids, such as that of Versatic acid glycidyl ester and (meth)acrylic acid, and reaction products of α-β-unsaturated glycidyl esters or ethers with monocarboxylic acids, for example, that of glycidyl methacrylate with stearic acid or linseed oil fatty acid.

Minor amounts of vinyl containing monomers I or II may be present to provide unsaturated graftable groups in the polyurethane chain. It is to be understood that these monomers are not chain stoppers and hence are not under the definition and counted as monomers IV. The addition of such monomers can be advantageous to reduce the amount of macromer having zero graftable unsaturated groups. However, the amount of such monomer should not be too high because this may also to some extent increase the amount of macromers having 2 or more graftable groups, which amount should be limited to less than 50 mol %. Therefore, the amount of vinyl containing monomers I or II is preferably less than 3, preferably less than 2 and more preferably less than 1 mole % (relative to the total mole of monomers in the macromer). Suitable monovinyl dihydroxy compounds are bis(hydroxyalkyl)vinyl compounds such as glycerol monovinyl ether, glycerol monoallyl ether and glycerol mono(meth)acrylate, or the corresponding compounds derived from trimethylolpropane. Further examples include adducts of α-β unsaturated carboxylic acids, such as (meth)acrylic acid, with diepoxides, for example, bisphenol (A) diglycidyl ether and hexanediol diglycidyl ether; adducts of dicarboxylic acids, for example, adipic acid, terephthalic acid or the like, with glycidyl (meth)acrylates.

In case the macromer has terminal hydroxy functional groups, suitable monomers IV are isocyanate functional monomers including dimethyl meta-isopropenyl benzyl isocyanate (m-TMI® monomer from Cytec Industries), isocyanato ethyl methacrylate (Karenz MOI from Showa Denko) or adducts of hydroxy functional monomers with such diisocyanates. Other suitable monomers IV are amino functional monomers including t-butylamino methacrylate, dimethylaminoethylmethacrylate.

In case the macromer has terminal isocyanate groups the chain stopper V can in principle be any compound having only one functional group reactive with isocyanate, for example monoalcohols or monoamines. Most preferably the chain stopper monomer V is an aliphatic mono-alcohol comprising at least 4 carbon atoms and most preferably at most 22 carbon atoms. In particular, the mono alcohol chain stopper (V) can be selected from the class of linear or branched C1-C22 aliphatic monoalcohols such as methanol, ethanol, n-propanol, iso-propanol, n-butanol, iso-butanol, tert-butanol, dodecanol, cetyl alcohol, cycloaliphatic or aromatic alcohols, and glycol ethers. Optionally, the monoalcohol can possess additional functional groups provided these are non-reactive towards isocyanate examples are hydroxy acetone, diacetone alcohol or hydroxyacids and hydroxyesters.

To prevent premature and/or uncontrollable polymerisation of the vinylic monomers during handling and subsequent condensation reactions, inhibitors can be added to the mixture. Examples of suitable inhibitors, are, without being limiting, hydroquinone, the monomethylether thereof, phenotiazine 2,4-dimethyl-6-tert.-butylphenol, 2,6di-tert.-butyl-4-methylphenol. These inhibitors can be used in concentrations up to 0.2% of the used monomers.

The urethane macromonomers are prepared by the conventional and known methods of urethane chemistry. In these methods the catalysts employed may be tertiary amines, for example, triethylamine, dimethylbenzylamine and diazabicyclooctane; and dialkyltin(IV) compounds, for example, dibutyltin dilaurate, dibutyl-tin-dichloride and dimethyltin-dilaurate. The synthesis of the macromer can be carried out without solvent in the melt, or in solution. Using a process where the macromer is prepared in solution is preferred. The solvent used may be an organic solvent or an ethylenically unsaturated monomer that carries no groups reactive to isocyanate. The latter method is preferred as the ethylenically unsaturated monomer will copolymerize in the subsequent emulsion polymerization yielding a solvent-free dispersion. Suitable solvents are those which can be removed subsequently by distillation or by entrainment with water. Examples include methyl ethyl ketone, methyl isobutyl ketone, acetone, tetrahydrofuran, toluene and xylene. These solvents may be distilled off, completely or partially, after the preparation of the polyurethane macromonomers or after the free-radical polymerization.

The macromonomers obtained by the synthesis described above are then neutralised, in case the ionic groups in the monomers containing such groups were not neutralised earlier. The neutralization of the acidic compounds is preferably carried out using aqueous solutions of alkali metal hydroxides, or with amines, for example, with trimethylamine, triethylamine, dimethylaniline, diethylaniline, triphenylamine, dimethylbenzylamine, dimethylethanolamine, aminomethylpropanol, or dimethylisopropanolamine, or with ammonia. In addition, the neutralization can also be carried out using mixtures of amines and ammonia. Other suitable bases can also be used. Alkaline compounds are preferably neutralised using aqueous solutions of inorganic acids, such as hydrochloric acid or sulphuric acid, or organic acid such as acetic acid. Other suitable acids may also be used.

For the preparation of the crosslinkable polymer binder dispersions the urethane macromers are converted to an aqueous emulsion by addition of water. After addition of (further) vinyl monomers, the macromonomers are polymerised by a free radical emulsion polymerization. The vinyl polymer can be polymerised in one or more steps by addition of separate portions of vinyl monomer with different monomer composition and/or different reaction conditions. The ratio of urethane macromer to vinyl addition polymer is 5:95 to 95:5.

Suitable initiators for the polymerization are the known free-radical initiators, such as ammonium peroxo-disulphate, potassium peroxo-disulphate, sodium peroxo-disulphate, and hydrogen peroxide. Organic peroxides such as cumene-hydroperoxide, t-butyl hydroperoxide, di-tert-butyl peroxide, dioctyl peroxide, tert-butyl perpivalate, tert-butylperisononanoate, tert-butylperethyl hexanoate, tert-butyl perneodecanoate, di-2-ethylhexyl peroxodicarbonate, diisotridecyl peroxodicarbonate, and azo compounds such as azobis(isobutyronitrile) and azobis(4-cyanovaleric acid). The conventional redox systems, for example, sodium sulphite, sodium dithionite, and ascorbic acid and organic peroxides or hydrogen peroxide are also suitable as initiators. Furthermore, regulators (thiols), emulsifiers, protective colloids and other conventional auxiliaries can also be added.

If the preparation of the macromonomers has been carried out in a solvent which can be removed by distillation and which forms with water an azeotrope having a boiling point below 100° C., for example, in acetone or xylene, then this solvent is finally removed from the dispersion by distillation. In each case, the result is an aqueous polyurethane dispersion.

The crosslinkable group can be on a vinyl monomer (VI) in the vinyl polymer and/or on the macromer, preferably on monomer I, II, on stabilizing monomer III and/or on the chain stopper (V). The binder can be crosslinked with a separate crosslinking agent that comprises crosslinking groups that on film formation can react with the crosslinkable groups on the binder. Alternatively, the binder can be crosslinkable by combining crosslinkable groups as well as crosslinking groups in the binder inter and/or intra molecularly. The crosslinkable groups can be on the vinyl part or on the PUR macromer part, the vinyl polymer and the macromer contain crosslinkable groups, the crosslinkable groups may be different, but preferably are the same.

A crosslinkable group (Ai) is a group that can react with a crosslinking group (Bi) on a crosslinking agent or on the binder itself. The crosslinkable group (Ai) on the vinyl can be chosen from the group A1 to A6 consisting respectively of amine, hydroxy, ketone, aldehyde, urea and oxyrane and the corresponding crosslinking group (Bi) is chosen from groups B1 to B6 wherein B1 is oxyrane, isocyanate, ketone, aldehyde and acetoacetoxy, B2 is methylol, etherified methylol, isocyanate and aldehydes, B3 is amino, hydroxide and aldehyde, B4 is amino and hydroxide, B5 is clyoxal and B6 is carboxyllic acid, amino and thiol. Preferably, the crosslinkable group on the binder is a carbonyl functional group and the crosslinking group is a hydrazide functional crosslinking group and preferably is on a separate crosslinking agent. Carbonyl functional groups include carbonyl groups and ketonaldehyde groups. Hydrazide functional groups include hydrazine, hydrazide or hydrazone groups.

In the polyurethane macromer, the crosslinkable group preferably is a ketone, aldehyde, urea and/or oxyrane group, and may be on one of the monomers I to V or may be on a separate monomer that can react with either of the other monomers constituting the polyurethane monomer. Examples of such monomers are known in the art. The crosslinkable group can also be the stabilising group of stabilizing monomer III. For example, in case the stabilising group in monomer III is a carboxylic acid group, the binder can be crosslinked on film formation with an epoxide crosslinking group on a separate crosslinking agent or on the binder. Also, the chain stopper V and the vinyl polymer may both comprise crosslinking functional groups, for example a carbonyl.

Preferably, the vinyl polymer part of the binder comprises a crosslinkable group. Suitable vinyl monomers with carbonyl functionality can be selected from, but are not limited to the acetoacetoxy esters of hydroxyalkyl acrylates and methacrylates, such as acetoacetoxyethyl (meth)acrylate, acetoacetoxy ethyl (meth)acrylamide, and keto-comprising amides such as diacetone (meth)acrylamide, (meth)acrolein, formyl styrene, 2-hydroxyethyl methacrylate acetoacetate, 2-hydroxypropyl acrylate acetyl acetate, butanediol-1,4 acrylate acetyl acetate, or a vinyl alkyl ketone, e.g., vinyl methyl ketone, vinyl ethyl ketone or vinyl butyl ketone,

Compounds with hydrazide functionality generally contain two or more hydrazine, hydrazide or hydrazone groups. The compounds, which preferably have a number average molecular weight (Mn) of <1.000 gr/mol, can be aliphatic, aromatic or mixed aliphatic/aromatic compounds and mixtures thereof. Examples of such compounds are bishydrazides of dicarboxylic acids having 2 to 12 carbon atoms, such as the bishydrazides of oxalic acid, malonic acid, succinic acid, glutaric acid, adipic acid, pimelic acid, suberic acid, azelaic acid, sebacic acid or the isomeric phthalic acids; carbonic acid bis-hydrazide, alkylene- or cycloalkylene-bis-semicarbazides, N,N′-diaminoguanidine, alkylenebishydrazines such as N,N′-diaminopiperazine, arylenebishydrazines such as phenylene- or naphthylenebishydrazine, alkylenebissemicarbazides, and bishydrazides of dialdehydes and diketones. Compounds (F) of higher functionality are, for example, the hydrazides of nitrilotriacetic acid or of ethylenediaminetetraacetic acid.

The invention also relates to the use of the binder according to the invention or the aqueous dispersion comprising said binder for the manufacture of coating compositions or adhesives. The invention in particular also relates to a coating composition comprising the binder or the aqueous dispersion comprising said binder according to the invention, further comprising one or more of the usual coating additives.

The invention is further illustrated by the following examples.

### Example 1

The following ingredients were weighed into a two liter three neck flask equipped with a mechanical stirrer, a condenser and an dropping funnel. The contents of the flask were heated to 60° C. under oxygen sparge, until a homogeneous mixture was obtained.

| | |
|---|---|
| n-Dodecanol | 139.8 grams |
| Polycaprolactone Diol* | 412.5 grams |
| Dimethylolpropionic acid | 100.5 grams |
| Hydroxy ethyl methacrylate | 97.50 grams |
| 2,6 di ter. Butyl-4-methylphenol | 3.57 grams |

(*Acid Value (mg KOH/g) <0.5, Molecular Weight = 550, OH Value (mg KOH/g) = 204 CAPA 200 from Solvay Interox)

Then 500.2 grams of isophorone diisocyante were dosed into the flask over a period of one hour. The temperature may not exceed 85° C. during the dosing. The reaction is continued at 80° C. until the residual isocyanate level is below 0.3%. The reaction mixture is cooled down to 60° C. and 535.9 grams of n-butyl acrylate is added. The solution is cooled down to room temperature and analyzed. The clear solution of the polyaddition polymer in n-butyl acrylate at a solids content of about 70% had a viscosity of 6.5 Pa·s, an acid value of 23.2 mg KOH/g and a color of 35 APHA. The molecular weight was determined by means of gel permeation chromatography on a PL gel 5 μm MIXED-C column using a mixture of THF with 2% of acetic acid as eluent, relative to polystyrene standards and was found to be Mn: 2067, Mw: 4593.

A three liter double jacketed glass reactor equipped with a four-blade stirrer, a condenser and inlets for addition of monomer, initiator, and other auxiliaries, was charged with 341.2 grams of the polymer solution prepared above. To this solution 9.79 grams of a 25% strength aqueous solution of ammonium hydroxide was added. The contents of the reactor were heated to 40° C. under a nitrogen blanket and 1323 grams of demineralised water was added under stirring to yield an emulsion of the polyaddition polymer and n-butyl acrylate in water. To this emulsion was added a monomer mixture consisting of 180.9 grams of methyl methacrylate, 173 grams of n-butyl acrylate and 19.05 grams of diacetone acrylamide. The emulsion was stirred for 30 minutes and 0.90 grams of a 70% strength solution of tertiary butyl hydroperoxide in water was added. A solution was made of 0.01 grams of iron sulphate heptahydrate, 0.01 grams of the di-sodium salt of ethylenediamine tetra acetate and 3.13 grams of demineralised water. This solution was added to the reactor. Then a solution of 0.63 grams of iso-ascorbic acid in 62.65 grams of demineralised water was dosed into the reactor over a period of 30 minutes. The temperature of the reaction-mixture rose to 63° C. In order to reduce the viscosity 105 grams of demineralised water was added to the reactor. Next a second monomer mixture consisting of 180.9 grams of methyl methacrylate, 276.2 grams of n-butyl acrylate and 19.05 grams of diacetone acrylamide was added to the reactor followed by 1000 grams of demineralised water. To the reactor 0.90 grams of a 70% strength solution of tertiary butyl hydroperoxide in water was added. A solution was made of 0.01 grams of iron sulphate heptahydrate, 0.01 grams of the di-sodium salt of ethylenediamine tetra acetate and 3.13 grams of demineralised water. This solution was added to the reactor. Then a solution of 0.63 grams of iso-ascorbic acid in 62.65 grams of demineralised water was dosed into the reactor over a period of 30 minutes. The temperature of the reaction-mixture was kept at 60° C. during the addition. After the addition of the iso-ascorbic acid solution, the contents of the reactor were kept at 60° C. for an additional 30 minutes. The batch was then cooled to 40° C. and 23.80 grams of adipic bishydrazide was added. The inlet was rinsed with 20 grams of demineralised water and the content of the reactor was kept at 40° C. for an additional 30 minutes. The batch was then cooled to ambient temperature and filtered.

The resulting product was a fine particle size dispersion (Z average mean diameter 85 nm) with a solids content of 30% and a pH of 7. When the dispersion was drawn down onto a glass plate it dried to a clear, hard film with high transparency.

### Example 2

246 grams of a polyester based on neopentyl glycol, diethylene glycol, adipic acid having a weight average molecular weight of 2680, a hydroxyl value of 67 and an acid value of 2.6 is weighed in two liter three neck flask equipped with a mechanical stirrer, a condenser and a dropping funnel. To this reactor 10.9 grams of hexanediol, 23 grams of dimethylolpropionic acid, 13.5 grams of dodecyl alcohol, 9.43 grams of hydroxyethyl methacrylate, 60 grams of methyl methacrylate and 1.07 grams of 2.6 di tertiary butyl-4-methoxyphenol were added. The mixture was heated to 50° C. under an oxygen sparge until a homogeneous mixture was obtained. Then 115.2 grams of isophorone diisocyanate were dosed into the flask over a period of one hour. The temperature is allowed to rise to 80° C. The contents of the flask are kept at 80° C. until the residual isocyanate content is less than 0.1%.

The reaction mixture is cooled to 70° C. and 16 grams of diacetone acrylamide dissolved in 57.3 grams of methyl methacrylate are added to the flask. After the mixture is homogeneous, 11,4 grams of dimethyl ethanolamine was added to the flask. After homogenization 658 grams of demineralised water are added to the flask over a period of one hour under vigorous stirring to emulsify the polyurethane. The temperature is kept at 70° C. during the emulsification. The emulsion is heated to 80° C. and 0.8 grams of tertiary-butyl hydroperoxide (70% strength) is added to the emulsion. After a 30 minutes hold period a solution of 1.3 grams iso-ascorbic acid dissolved in 130 grams of demineralised water are added in 90 minutes. The polymer dispersion is cooled to 65° C. and 8.2 grams of adipic dihydrazide are added to the polymer dispersion. The dispersion was kept at 65° C. for an additional 30 minutes. Than the batch was cooled down to 30° C. and filtered. The resulting urethane-acrylic dispersion had a solids content of 40.1%, a pH of 7.4 and a particle size of 81 nm (Malvern Zetasizer).

### Example 3

378.4 grams of a polyester based on neopentyl glycol, diethylene glycol, adipic acid having a weight average molecular weight of 2680, a hydroxyl value of 67 and an acid value of 2.6 is weighed in two liter three neck flask equipped with a mechanical stirrer, a condenser and a dropping funnel. To this reactor 209.2 grams of hexanediol, 75.6 grams of dimethylolpropionic acid, 60.37 grams of dodecyl alcohol, 42.2 grams of hydroxyethyl methacrylate, 271.2 grams of methyl methacrylate and 3.3 grams of 2.6 di tertiary butyl-4-methoxyphenol were added. The mixture was heated to 50° C. under an oxygen sparge until a homogeneous mixture was obtained. Then 634.2 grams of isophorone diisocyanate were dosed into the flask over a period of one hour. The temperature is allowed to rise to 80° C. The contents of the flask are kept at 80° C. until the residual isocyanate content is less than 0.1%.

The reaction mixture is cooled to 70° C. and 52.73 grams of diacetone acrylamide dissolved in 105.5 grams of methyl methacrylate are added to the flask. After the mixture is homogeneous it is cooled and poured in a suitable container for storage. To 698.9 grams of the polyurethane described above, 14.33 grams of dimethyl ethanolamine were added in a two liter three-necked flask. After homogenization 822.5 grams of demineralised water are added over a period of one hour under vigorous stirring to emulsify the polyurethane. The temperature is kept at 70° C. during the emulsification. The emulsion is heated to 80° C. and 1.0 grams of tertiary-butyl hydroperoxide (70 strength) are added to the emulsion. After a 30 minutes hold period a solution of 1.625 grams iso-ascorbic acid dissolved in 162.5 grams of demineralised water are added in 90 minutes. The polymer dispersion is cooled to 65° C. and 10.25 grams of adipic dihydrazide are added to the polymer dispersion. The dispersion was kept at 65° C. for an additional 30 minutes. Than the batch was cooled down to 30° C. and filtered. The resulting urethane-acrylic dispersion had a solids content of 41.6%, a pH of 7.6 and a particle size of 98 nm (Malvern Zetasizer).

Comparative Experiment 4 (following the teaching of U.S. Pat. No. 5,623,016).

246 grams of a polyester based on neopentyl glycol, diethylene glycol, adipic acid having a weight average molecular weight of 2680, a hydroxyl value of 67 and an acid value of 2.6 is weighed in two liter three neck flask equipped with a mechanical stirrer, a condenser and a dropping funnel. To this reactor 10.9 grams of hexanediol, 23 grams of dimethylolpropionic acid, 18.9 grams of hydroxyethyl methacrylate and 1.07 grams of 2.6 di tertiary butyl-4-methoxyphenol were added. The mixture was heated to 50° C. under an oxygen sparge until a homogeneous mixture was obtained. Then 115.2 grams of isophorone diisocyanate were dosed into the flask over a period of one hour. The temperature is allowed to rise to 80° C. The contents of the flask are kept at 80° C. until the residual isocyanate content is less than 0.1%.

The reaction mixture is cooled to 70° C. and 16 grams of diacetone acrylamide dissolved in 117.3 grams of methyl methacrylate are added to the flask. After the mixture is homogeneous, 11.4 grams of dimethyl ethanolamine was added to the flask. After homogenization 658 grams of demineralised water are added to the flask over a period of one hour under vigorous stirring to emulsify the polyurethane. The temperature is kept at 70° C. during the emulsification. The emulsion is heated to 80° C. and 0.8 grams of tertiary-butyl hydroperoxide (70% strength) is added to the emulsion. After a 30 minutes hold period a solution of 1.3 grams iso-ascorbic acid dissolved in 130 grams of demineralised water are added in 90 minutes. The polymer dispersion is cooled to 65° C. and 8.2 grams of adipic dihydrazide are added to the polymer dispersion. The dispersion was kept at 65° C. for an additional 30 minutes. Than the batch was cooled down to 30° C. and filtered. The resulting urethane-acrylic dispersion had a solids content of 40.4%, a pH of 7.6 and a particle size of 163 nm (Malvern Zetasizer).

### Example 5

### Paint Evaluation of Urethane-Acrylic Hybrids

Varnishes were formulated by blending 100 grams of the urethane-acrylic dispersions from Example 3 and Comparative Experiment 4 with 2 grams of a 10% solution of Nuvis FX 1010 (ex. Elementis) in a water/butylglycol mixture (75/25). An amount of butyl glycol was added sufficient to obtain a clear film without cracks when dried at 23° C. After 7 days of drying the hardness of the film were measured according to Persoz (ISO 1522). The results are given in table 1.

TABLE 1
Persoz hardness.

| Varnish based on | Hardness (s) |
|---|---|
| Example 3 | 112 |
| Comp. Exp. 4 | 87 |

Even though the degree of crosslinking based on the presence of acryloyl functional polyurethane is two times as high for Comp. Exp. 4, the hardness of the varnish based on example 3 is significantly higher that that based an Comp. Exp. 4.

The varnishes were applied onto wooden veneered panels (30-35 micron dry layer thickness) by spraying and dried for 7 days at 23° C. The chemical resistance properties according to German standard DIN 68861 Part 1B are given in table 2.

TABLE 2
Chemical resistance properties according to DIN 68861 Part 1B.

| Substance | exposure time | | Example 3 | Comp. Exp. 4 |
|---|---|---|---|---|
| Ammonia (25%) | 2 | min. | 0 | 0 |
| Ethanol (50%) | 60 | min. | 0-1 | 0-1 |
| Olive oil | 16 | h | 0 | 1 |
| Red wine | 5 | h | 0 | 4 |
| Coffee | 16 | h. | 1 | 3 |
| Atrix (handcream) | 5 | h. | 0 | 0 |
| Cleanser solution | 5 | h. | 0 | 0 |

Rating: 0 = no change in film appearance, 5 = film completely destroyed.

The resistance against sweat and saliva was determined of the same panels according to DIN 53160.

| exposure time (at 40° C.) | | 2 h | 5 h |
|---|---|---|---|
| Varnish | Example 3 | 0 | 0 |
| | Experiment 4 | 0-1 | 1 |
| | (comp.) | | |

Rating: 0 = no change in film appearance, 5 = film completely destroyed.

### Examples 6 to 8

A number of polyurethane solutions in acrylic monomer where made according to the method outline above but with the raw material compositions given in table 3.

TABLE 3

| Example | 6 | 7 | 8 |
|---|---|---|---|
| polyester used in example 2 and 3 | 615.00 | 615.00 | |
| Therathane 2000 (ex. Dupont) | — | | 910.00 |
| 1.6-hexane diol | 27.25 | | 27.25 |
| dimethylol propionic acid | 57.50 | 57.50 | 57.50 |
| n-butanol | 13.42 | | |
| dodecyl alcohol | — | 33.75 | 33.75 |
| Hydroxyl acetone | | | |
| carbonyl functional diol* | — | 45.09 | — |
| methyl methacrylate | 213.30 | 213.30 | 213.30 |
| hydroxyethyl methacrylate | 40.42 | 40.42 | 40.42 |
| 2.6 di tertiary butyl-4-methoxyphenol | 2.68 | 2.68 | 2.68 |
| isophorone diisocyanate | 288.00 | 288.00 | 288.00 |
| methyl methacrylate | 80.00 | 80.00 | 80.00 |
| diacetone acrylamide | 20.00 | 20.00 | 20.00 |

*Addition product of 1 mole diacetone acryl amide to 1 mole of diethanol amine.

The molecular weight of the polyurethane was determined by means of gel permeation chromatograph (THF as eluent, relative against polystyrene standards). The values found are given in Table 4.

TABLE 4

| Example | 6 | 7 | 8 |
|---|---|---|---|
| Number average MW | 3673 | 3848 | 5045 |
| Weight average MW | 11127 | 12360 | 18507 |

### Examples 9 to 11

Urethane-acrylic dispersions were synthesised along the route describe in examples 2 and 3 using the polyurethane solutions from examples 6 to 8. The raw material compositions are given in table 5.

TABLE 5

| Example | 9 | 10 | 11 |
|---|---|---|---|
| Polyurethane solution from example 6 | 692.60 | — | — |
| Polyurethane solution from example 7 | — | 707.90 | — |
| Polyurethane solution from example 8 | — | — | 846.40 |
| Dimethylethanol amine | 14.33 | 14.33 | 14.33 |
| Demineralised water | 822.50 | 822.50 | 822.50 |
| ter.-butyl hydroperoxide (70% aqueous) | 1.00 | 1.00 | 1.00 |
| iso-ascorbic acid | 1.63 | 1.63 | 1.63 |
| Demineralised water | 162.50 | 162.50 | 162.50 |
| adipic dihydrazide | 10.25 | 20.27 | 10.25 |

The urethane-acrylic dispersions obtained were characterised. The values found are given in table 6.

TABLE 6

| Example | 9 | 10 | 11 |
|---|---|---|---|
| solids content (%) | 40.6 | 41.9 | 41 |
| PH | 7.6 | 7.6 | 7.6 |
| Particle size (nm) | 81.3 | 108.3 | 94.6 |

What is claimed is:

1. A crosslinkable polymer binder comprising a polyurethane macromer and grafted thereon a vinyl polymer, the macromer being prepared by reacting:
a monomer (I) comprising 2 or more hydroxy functional groups,
a monomer (II), comprising 2 or more isocyanate functional groups,
a stabilizing monomer (III) comprising at least one of ionically and non-ionically stabilising groups,
a graft monomer (IV) having only one group reactive with monomer I or II and one vinyl group,
a chain stopper monomer (V) having only one group reactive with monomer I or II, which chain stopper (V) is a monoamine or a monoalcohol selected from the class of linear or branched C1-C22 aliphatic monoalcohols or aromatic alcohols,
wherein at least 30 mole %, of the macromers have only one graft monomer IV and less than 50 mole % of the macromers have two or more graft monomers IV, wherein the vinyl polymer is linked to the vinyl group of graft monomer IV and wherein at least one of the vinyl polymer and the macromer comprise crosslinkable groups.

2. The binder according to claim 1, wherein the polyurethane macromer is linear and wherein monomer (I) comprise 2 hydroxy functional groups and monomer (II) comprise 2 isocyanate functional groups.

3. The binder according to claim 1, wherein the ratio of molar amount of monomer IV to V is 0.5:1 to 2:1.

4. The binder according to claim 1, wherein the ratio of molar amount of monomer IV to V is 0.75:1 to 1.25:1.

5. The binder according to claim 1, wherein the macromer has a weight average molecular weight of at least 3,000 gr/mol (as determined by GPC).

6. The binder according to claim 5, wherein the weight average molecular weight is at most 50,000 gr/mol (as determined by GPC).

7. The binder according to claim 1, wherein monomer II is present in such amount to provide a molar excess of isocyanate groups relative to isocyanate-reactive groups in monomers I and III, and wherein monomer IV and V comprise only one isocyanate-reactive group.

8. The binder according to claim 7, wherein monomer II is present in an amount sufficient to form isocyanate terminated macromers.

9. The binder according to claim 1, wherein the number of macromers having 2 or more graft monomers is at most 35 mole %, and the number of macromers having no graft monomers is at most 35 mole %, and the number of macromers having only 1 graft monomers is between 20 and 80 mole %.

10. The binder according to claim 1, wherein chain stopper V is an aliphatic mono-alcohol comprising 4 to 22 carbon atoms.

11. The binder according to claim 1, wherein the monomer (I) is a polyester diol or a polycaprolactone polyol.

12. The binder according to claim 1, wherein the crosslinkable group is a carbonyl functional group.

13. The binder according to claim 1, wherein the binder is in an aqueous dispersion, and wherein the aqueous dispersion further comprises a separate crosslinking agent.

14. The binder according to claim 1, wherein the binder is in a coating composition.

15. A process for the manufacturer of a crosslinkable polymer binder comprising a polyurethane macromere and grafter thereon a vinyl polymer, comprising the steps of:
(1) forming a macromer by reacting;
a monomer (I) comprising 2 or more hydroxy functional groups,
a monomer (II), comprising 2 or more isocyanate functional groups,
a stabilizing monomer (III) comprising at least one of ionically and non-ionically stabilising groups,
a graft monomer (IV) having only one group reactive with monomer I or II and one vinyl group,
a chain stopper monomer (V) having only one group reactive with monomer I or II, wherein the amount of chain stopper monomer V relative to the amount of graft component IV is chosen such that at least 30 mole % of the macromers have only one graft monomer IV and less than 50 mole % of the macromers have two or more graft monomers IV;
(2) adding vinyl monomer before, during or after step (1);
(3) optionally neutralizing the obtained reaction product,
(4) emulsifying the obtained reaction product in water;
(5) after emulsifying adding a radical starter to react the vinyl monomers,
wherein at least one of the vinyl polymer and the macromer comprise crosslinkable groups.

16. The process of claim 15, wherein in step (2), an inhibitor is also added before, during or after step (1).

17. The process according to claim 15, wherein at least 50% of the macromer as formed in step (1) has only 1 graft monomer IV.

18. The process according to claim 15, wherein reaction step (1) is performed using at least one of vinyl monomers of step (2) and mono-alcohol monomer V as reaction solvent.

19. The process of claim 17, wherein reaction step (1) is performed without using additional solvents.

20. The process according to claim 15, wherein the vinyl monomers in step (2) are added in at least 2 portions having a different composition of vinyl monomers.

21. The process according to claim 15, wherein vinyl monomer is added before and after forming the macromer in step (1).
